(19) United States
(12) Patent Application Publication
(10) Pub. No.: US 2016/0018809 A1
(43) Pub. Date: Jan. 21, 2016

(54) LADDER CHART CREATION DEVICE, MONITORING DEVICE, COMPUTER PROGRAM, AND MACHINE CONTROL DEVICE

(71) Applicant: KABUSHIKI KAISHA YASKAWA DENKI, Kitakyushu-shi (JP)

(72) Inventor: Naoki MIZUNO, Kitakyushu-shi (JP)

(73) Assignee: KABUSHIKI KAISHA YASKAWA DENKI, Kitakyushu-shi (JP)

(21) Appl. No.: 14/802,180

(22) Filed: Jul. 17, 2015

(30) Foreign Application Priority Data
Jul. 18, 2014 (JP) 2014-148325

(51) Int. Cl. G05B 19/05

(52) U.S. Cl. CPC G05B 19/056; G05B 2219/13048

(57) ABSTRACT

A ladder program device includes circuitry which stores a register value to be used in a ladder program, displays the register value in a register value display area, and receives a selection for one of a first rewrite input and a second rewrite input for the register value displayed in the registered value display area, the circuitry receives the selection by accepting the first rewrite input if a value to modify the register value is entered and accepting the second rewrite input if at least one portion of the register value display area is selected to modify the register value.

### CROSS-REFERENCE TO RELATED APPLICATIONS

The present application is based upon and claims the benefit of priority to Japanese Patent Application No. 2014-148325, filed Jul. 18, 2014, the entire contents of which are incorporated herein by reference.

### BACKGROUND OF THE INVENTION

1. Field of the Invention

The present invention relates to a ladder chart creation device, a monitoring device, a computer program, and a machine control device.

2. Description of Background Art

A ladder program based on a ladder chart may describe operations of a controller used to control an industrial machine. Within the controller executing the ladder program, the values in the registers in the ladder program can change minute by minute as the ladder program is executed.

### SUMMARY OF THE INVENTION

According to one aspect of the present invention, a ladder program device includes circuitry which stores a register value to be used in a ladder program, displays the register value in a register value display area, and receives a selection for one of a first rewrite input and a second rewrite input for the register value displayed in the registered value display area. The circuitry receives the selection by accepting the first rewrite input if a value to modify the register value is entered and accepting the second rewrite input if at least one portion of the register value display area is selected to modify the register value.

According to another aspect of the present invention, a method for monitoring a register value includes storing a register value to be used in a ladder program, displaying the register value in a register value display area, specifying which one of a first rewrite input and a second rewrite input for the register value displayed in the registered value display area is to be selected for the register value, receiving a selection for one of the first rewrite input and the second rewrite input for the register value by accepting the first rewrite input if a value to modify the register value is entered and accepting the second rewrite input if at least one portion of the register value display area is selected, and specifying a mode of display for the register value when the second rewrite input is selected to modify the register value.

According to yet another aspect of the present invention, a machine control device includes a non-transitory computer readable medium having stored thereon a program that when executed by an external electronic device causes the external electronic device to execute a method of monitoring a register value, and circuitry which connects to the external electronic device, determines whether the program is installed on the external electronic device, and transfers the program to the electronic device if the program is not installed on the external electronic device. The method includes storing the register value to be used in a ladder program, displaying the register value in a register value display area, specifying which one of a first rewrite input and a second rewrite input for the register value displayed in the registered value display area is to be selected for the register value, and receiving a selection for one of the first rewrite input and the second rewrite input for the register value by accepting the first rewrite input if a value to modify the register value is entered and accepting the second rewrite input if at least one portion of the register value display area is selected to modify the register value.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an example configuration of a machine control system including a ladder program creation device according to an embodiment of the invention;

FIG. 2 is a block diagram illustrating a physical configuration of the ladder program creation device;

FIG. 3 is a functional block diagram illustrating an example of a functional configuration of the machine control system;

FIG. 4 illustrates an example of a screen displayed on a monitor connected to the ladder program creation device;

FIG. 5 illustrates an example of a register value display area;

FIG. 6 illustrates another example of a register value display area;

FIG. 7 illustrates an example of switching the display of independently selectable buttons;

FIG. 8 illustrates an example of a display that uses a bar graph;

FIG. 9 illustrates an example of the register value display area when all the registers are displayed in a list;

FIG. 10 is a flow diagram illustrating an operation for monitoring the register values using a monitoring unit;

FIG. 11 illustrates an example configuration of a machine control system wherein a monitoring device is connected to the machine control device;

FIG. 12 is a functional block diagram of a machine control system wherein a monitoring device is connected to the machine control device; and

FIG. 13 is a flow diagram illustrating the operations of the machine control device when the monitoring device is connected thereto.

### DETAILED DESCRIPTION OF THE EMBODIMENTS

The embodiments will now be described with reference to the accompanying drawings, wherein like reference numerals designate corresponding or identical elements throughout the various drawings.

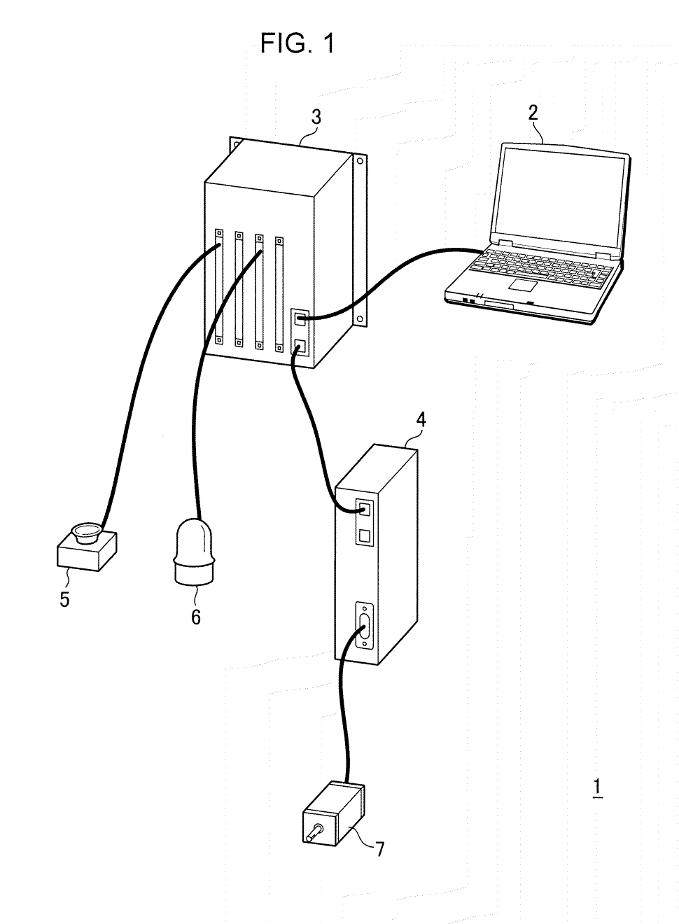

FIG. 1 illustrates an example configuration of a machine control system 1 including a ladder program creation device 2 according to an embodiment of the invention. In FIG. 1, in addition to the ladder program creation device 2 and the machine control device 3, the example machine control system 1 includes a servo controller 4, a switch 5, and a lamp 6 all connected to the machine control device 3. A servo motor 7 is also connected to the servo controller 4.

Overall, the machine control system 1 primarily supports various kinds of automated devices generally recognized as industrial machines (FA devices) and performs automated or semiautomated control thereof. The various devices illustrated in FIG. 1 exemplify these kinds of industrial machines.

The machine control device 3 controls the operations of various devices connected thereto on the basis of a ladder program. Here, the machine control device 3 is an industrial controller, and may be a sequencer or a programmable logic controller (PLC). The ladder program creation device 2, generates a ladder chart, converts the ladder chart into a ladder program executable on the machine control device 3, and transfers the program to the machine control device 3. Here, the ladder program creation device 2 displays a register value used in a ladder program run on the machine control device 3 in real time on a monitor connected to the ladder program creation device 2. The ladder program creation device 2 is also provided with a monitoring function that rewrites the aforementioned register value in accordance with commands from a user. Although various kinds of devices may be used to function as the ladder program creation device 2 as is later described, as illustrated in FIG. 1, the ladder program creation device 2 may be realized through running a computer program with the functions of the ladder program creation device 2 on a typical computer. The aforementioned computer program may be stored on various kinds of computer readable storage media such as an optical disk, or a semiconductor memory, and may be installed on the computer from said media. Alternatively, the computer program may be downloaded to the computer from various kinds of information communication networks such as the Internet, or maybe implemented such that the various functions thereof are provided by a remote server via the information communication network, i.e., via what is known as cloud computing.

Here, the term “ladder chart” is used to indicate a human readable graphical representation as well as the ladder chart itself. Furthermore, the term “ladder program” is used to indicate a ladder chart converted to electronic data that can be interpreted and executed by the machine control device 3.

In the above description and in FIG. 1, detailed configurations and wiring not pertinent to describing the embodiment, such as connections to the power line, ground line, or the like are omitted from the drawings and the description. In addition, neither the embodiment nor the invention is particularly limited to the various types of connection modes, the connection types, or the like. Finally, the operations of the machine control device 3 are possible regardless of whether the ladder program creation device 2 is connected thereto.

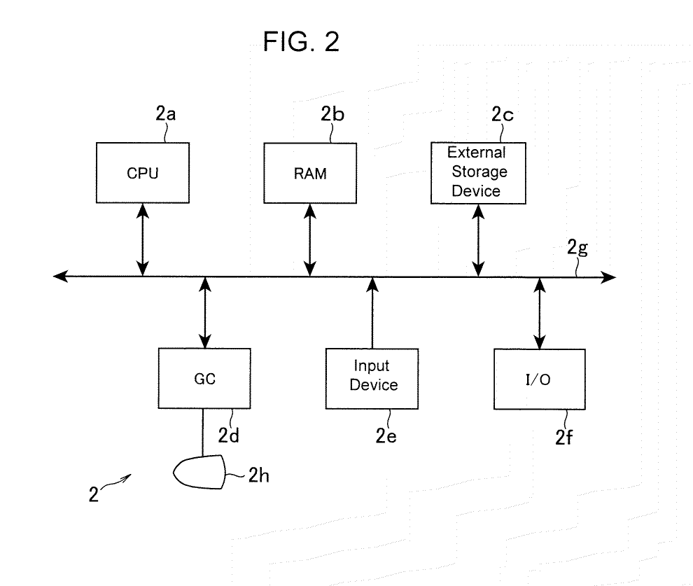

FIG. 2 is a block diagram illustrating a physical configuration of the ladder program creation device 2. The ladder program creation device 2 may be the above-described general computer wherein a central processing unit (CPU) (2a), a random access memory (RAM) (2b), an external storage device (2c), a graphics controller (GC) (2d), an input device (2e), and an input output (I/O) unit (2f) are mutually connected via a data bus (2g) for exchanging electronic signals. Here, the external storage device (2c) is capable of storing information statically, and is, for example, a hard drive (HDD), or a solid-state drive (SSD). Signals from the GC (2d) are output as an image to a monitor (2h) such as a flat panel display where a user may visually recognize the image. The input device (2e) is a device that allows the user to input information such as a keyboard, a mouse, or a touch screen panel. The I/O (2f) is an interface that allows the ladder program creation device 2 to exchange information with an external device, which, in this case is the machine control device 3.

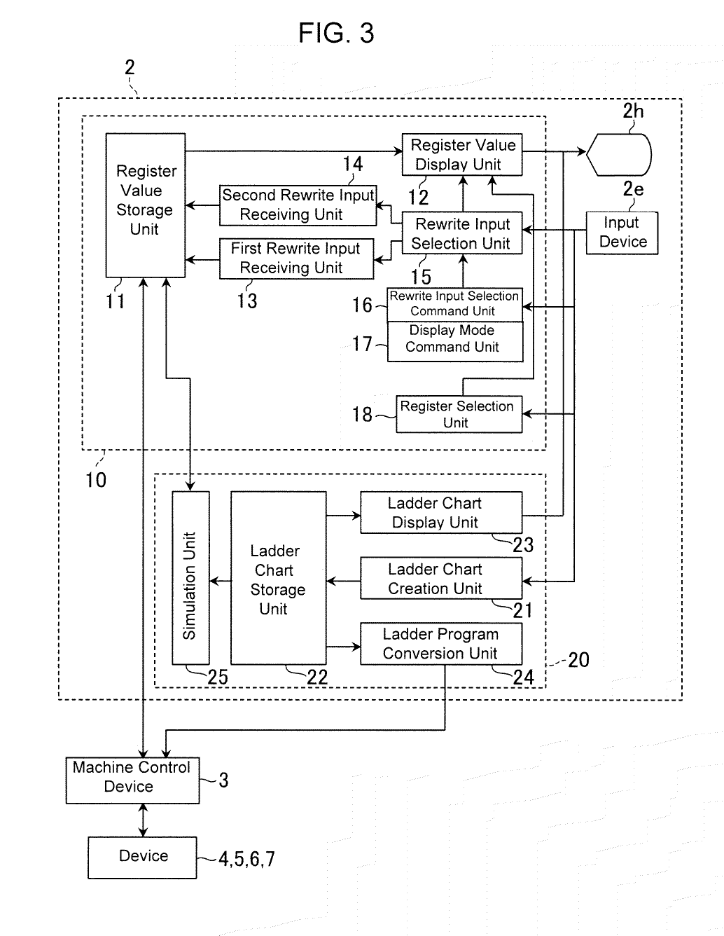

FIG. 3 is a functional block diagram illustrating an example functional configuration of the machine control system 1. Using the physical configuration of the ladder program creation device 2 described above, each function block depicted inside the ladder program creation device 2 in FIG. 3 in particular highlights individual functions in the ladder program creation device 2 and are depicted separately. Furthermore, for instance, each function may be realized virtually by the CPU (2a) executing a predetermined program, or by assigning an area in the RAM (2b) or an external storage device (1c) to store predetermined information. Accordingly, the function blocks illustrated in the drawing do not mean that the physical configuration of the ladder program creation device 2 and the program modules executed in the ladder program creation device 2, or the programs themselves are separated into each of these function blocks. In addition, not all the functions of the ladder program creation device 2 are illustrated in the drawing; the portions of little technical relevance to an embodiment of the invention are excluded from the drawing.

First is described the monitoring unit 10 which primarily implements the above-described monitoring function. The monitoring unit 10 is provided with a register value storage unit 11. The register value storage unit 11 stores the register values used in the ladder program run on the machine control device 3, and updates the register values in real time via appropriate communications when the machine control device 3 is connected to the ladder program creation device 2. Furthermore, rewriting the register values stored in the register value storage unit 11 rewrites the register values maintained in the machine control device 3.

In the example provided here, the ladder program creation device 2 is structured to simulate the operations in the ladder chart created by the ladder program creation device 2 when the machine control device 3 is not connected thereto. A later-described simulation unit 25 also stores the register values used by the simulation unit 25 when the unit simulates the operations of the ladder chart, and the changes to the register values are reflected therein in real time.

A register value display unit 12 displays a portion or all of the register values stored in the register value storage unit 11 on the monitor (2h). The modes of display are described later.

A first rewrite input receiving unit 13 and a second rewrite input receiving unit 14 receive input for rewriting the register values stored in the register value storage unit 11 on the basis of input from the input device (2e). A rewrite input selection unit 15 selects at least one of the first rewrite input receiving unit 13 and the second rewrite input receiving unit 14. The differences in the operations of the first rewrite input receiving unit 13 and the second rewrite input receiving unit 14 are described later.

A rewrite input selection command unit 16 specifies which of at least the first rewrite input receiving unit 13 and the second rewrite input receiving unit 14 the rewrite input selection unit 15 will select on the basis of input from the input device (2e). Additionally, a display mode command unit 17 specifies how a register value is displayed by the register value display unit 12 when the rewrite input selection command unit 16 specifies the second rewrite input receiving unit 14. The details of these operations are described later.

A register selection unit 18 selects a register stored in the register value storage unit 11 whose value is displayed by the register value display unit 12 on the monitor (2h) on the basis of input from the input device (2e).

Next, the ladder program creation unit 20 is described. The ladder program creation unit 20 primarily realizes the functions used to create a ladder program. The ladder program creation unit 20 includes a ladder chart creation unit 21 that creates a ladder chart on the basis of input from the input device (2e); a ladder chart storage unit 22 that stores an already-created or a partially-created ladder chart; a ladder chart display unit 23 for displaying on the monitor (2h) an already-created or a partially-created ladder chart; a ladder program conversion unit 24 which converts the already-created ladder chart into a ladder program and transfers the ladder program to the machine control device 3; and a simulation unit 25 that simulates the operations of an already-created ladder chart.

The functions realized in the ladder program creation unit 20 are identical to the functions provided in commercial applications used for creating a ladder programs. A detailed explanation of the operations of each module is omitted given that no special explanation is needed. Note, given that the simulation unit 25 is not essential to the function of the ladder program creation unit 20, the simulation unit 25 can be excluded. Alternatively, although the simulation unit 25 simulates the operations of the ladder program on the basis of the ladder chart stored in the ladder chart storage unit 22 in the configuration illustrated in FIG. 3, the simulation unit 25 may be structured instead to simulate operations on the basis of a ladder program converted from a ladder chart by the ladder program conversion unit 24.

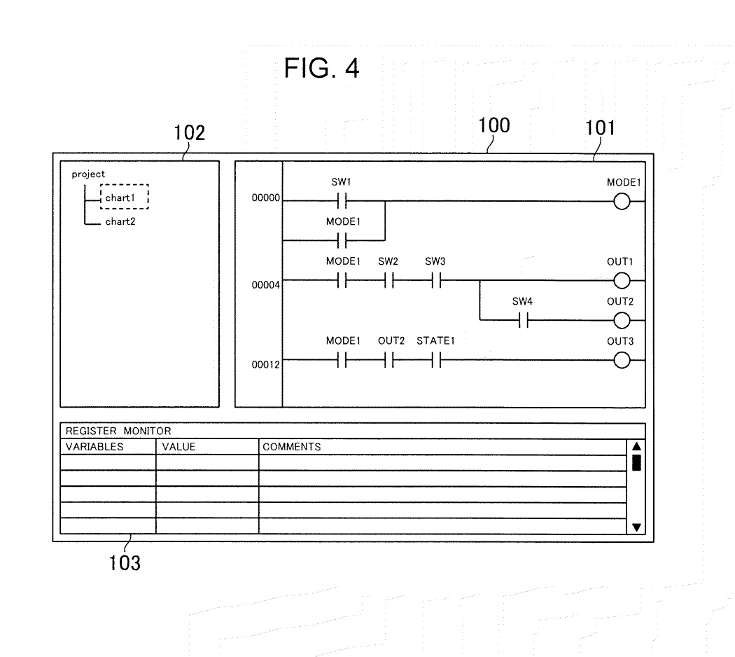

FIG. 4 illustrates an example screen 100 displayed on a monitor (2h) connected to the ladder program creation device 2. In the example, the screen 100 includes a ladder chart display area 101 which displays an already-created or a partially-created ladder chart; a project display area 102 which allows and indicates the selection of a ladder chart displayed in the ladder chart display area 101 when multiple ladder charts are included in a single project; and a register value display area 103 which displays the register values used in the ladder program that is selected or is running;

Referring to FIG. 3, the ladder chart display unit 23 in the ladder program creation unit 20 displays the ladder chart display area 101 and the project display area 102 on the onitor (2h), while the register value display unit 12 in the monitoring unit 10 displays the register value display area 103 on the monitor (2h).

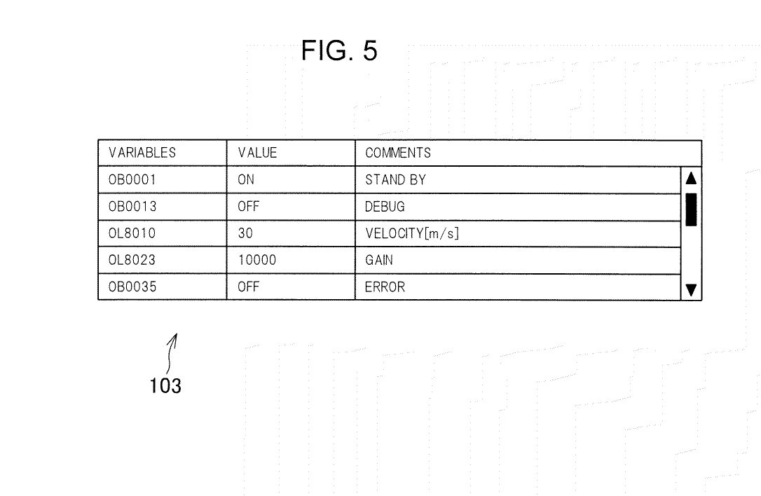

FIG. 5 illustrates an example of the register value display area 103. In the example, the register value display area 103 presents selected register values and other information in a table. Each column in the table corresponds to the field indicated, and in this example from left to right are the name of the register (number), the value, and a comment associated with the register. Of course, the fields depicted here are examples of the information related to a register that should be displayed. Other information from required fields may be shown instead of or in addition to the fields depicted. Each row in the table corresponds to a register, and the topmost row in the table indicates the field names.

Here, the column representing the register values displays from the top row, the values “ON, “OFF”, “30”, and “10000” respectively. Here the values “ON”, and “OFF” represent values in a binary register, and respectively correspond to one and zero. Thus, these values pose no problem if displayed as “1” and “0”.

When the register values are merely displayed as is in the register value display area 103 as illustrated, a user needs to carry out the following procedure to rewrite a register value.

First, the user selects the cell for the register value the user wishes to rewrite. When using a pointing device such as a mouse, moving the cursor over the desired cell and clicking the appropriate button, such as the left button, selects the cell. As a result, the relevant cell changes to a state of waiting for input, and thus the user may use a suitable input device such as a keyboard to input the desired value. When desiring to change the “ON” or “OFF” register values, a user may enter the desired numerical values “1” or “0” respectively.

Thus, an entry for rewriting the register value, that is, a rewrite input may be received by the user entering the value to be written. This method, however, requires two stages of operations: selecting the cell to be rewritten, and entering the desired value. While the range of values that may be rewritten to a register varies by register, there is no limit on the value that may be entered via the input device. Therefore, there may be cases where the rewrite input cannot be accepted when the value entered is outside the valid range of values for the register.

In this manner, direct entry of a value to be written may be accepted via the first rewrite input receiving unit 13 illustrated in FIG. 3.

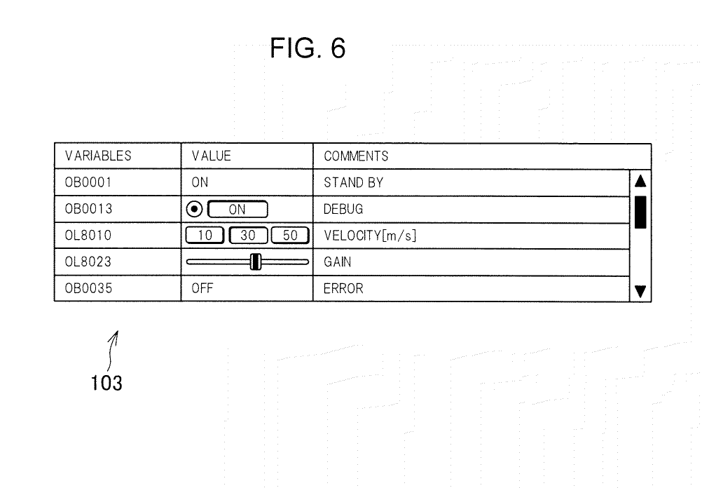

In contrast, FIG. 6 illustrates another example of the register value display area 103. The registers illustrated in FIG. 6 are identical to the registers illustrated in the above FIG. 5; however, the values of the registers (OB0013, OL8010, OL8023) in rows two to five are displayed using different modes. More specifically, the value for the register (OB0013) in the second row is represented by an indicator lamp and a pushbutton. The values for the register (OL8010) in the third row are each represented by pushbuttons. Finally, the values for the register (OL8023) in the fourth row are depicted with a slide bar.

Consequently, when the register values are not merely presented as the values themselves but presented using some kind of pattern, the user may manipulate the respective patterns in accordance with the form thereof when rewriting the register value.

For instance, in the case of the register (OB0013) in the second row, the user may select the pushbutton displayed the relevant cell, that is, the user may press the pushbutton in the graphical user interface (GUI) to alternate the value of the register between the values “1” and “0”. When the register value is “1”, the indicator lamp is lit as illustrated in the drawing, and the pushbutton is displayed as pressed. When the register value is “0” on the other hand, the indicator lamp is unlit, and the pushbutton is displayed as unpressed.

In the case of the register (OL8010) in the third row, the user may select any of the pushbuttons displayed in that cell, that is, the user may press any of the pushbuttons in the GUI to thereby switch the register value to the value displayed on the pushbutton, or in other words, to switch the register value to a value corresponding to the value displayed on the pushbutton. For instance, a register value is rewritten to the value “30” when the user presses the center pushbutton which displays the value “30”. As illustrated in FIG. 6, the selected pushbutton is displayed as being pressed, while the other pushbuttons are displayed as being unpressed, and thus the user can immediately recognize the currently selected register value.

Finally, in the case of the register (OL8023) in the fourth row, the user may select and drag the slide bar displayed in that cell to a specific position, that is, the user may grab and move the slider on the slide bar in the GUI to switch the register value to a value corresponding to the position of the slider. As illustrated in the drawing, the position of the slider represents the register value.

Thus, as above described, when the register values are displayed using some kind of pattern representing a human-machine interface (HMI), the rewrite input can be received by selecting at least a portion of the register value display area 103. Receiving the rewrite input may be realized through the second rewrite input receiving unit 14 illustrated in FIG. 3.

Thus, an entry for rewriting the register value, that is, a rewrite input may be received by selecting at least a portion of the register value display area 103. This method merely requires selecting a certain location on a screen to rewrite the register value, and thus provides for intuitive and efficient operation. In addition, the register value that should be rewritten may be switched between and selected from two or more predetermined values, or selected from a range of predetermined numerical values. Therefore, it is unlikely that a numerical value outside the valid range of register values will be specified. When entering a value using the above-described pushbutton in particular, the value can be rewritten via a simple operation, i.e., via a so-called one-touch operation. Additionally, a numerical value may be entered intuitively when using the above-described slide bar.

The rewrite input selection unit 15 in FIG. 3 selects which of the above-described methods will be used to accept the rewrite input for a specific register. In other words, the rewrite input selection unit 15 selects whether the first rewrite input receiving unit 13 or the second rewrite input receiving unit 14 accepts the rewrite input for each register. The selections are alternatives. In other words, either one of the first rewrite input receiving unit 13 and the second rewrite input receiving unit 14 may be selected to receive the rewrite input. The register value display unit 12 then changes the mode of the display of the register value in the register value display area 103 in accordance with the result of the selection by the rewrite input selection unit 15. Namely, as previously indicated, when the first rewrite input receiving unit 13 is selected the register value itself is displayed in the register value display area 103, and when the second rewrite input receiving unit 14 is selected, the register value is displayed graphically in the register value display area 103 as a pattern corresponding to the register value. Hereby, the current value of the register may be known intuitively. Additionally, the method that may be used to rewrite the register value, that is, entering a numerical value via the first rewrite input receiving unit 13, or location selection via the second rewrite input receiving unit 14 may be immediately understood. Finally, a numerical display may be used as is for registers that do not require graphical representation.

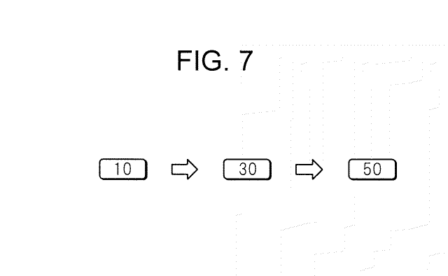

When the second rewrite input receiving unit 14 is selected, the display mode for the register value is not limited to the form exemplified in FIG. 6; other forms may be used. For example, instead of the pushbuttons displayed for the register (OL8010) in the third row in FIG. 6, the display may switch between independent pushbuttons as illustrated in FIG. 7. Namely, the current register value is displayed on the pushbutton and the register value switched in order to a predetermined value each time the pushbutton is pressed. In the example, the register value switches from 10, to 30, to 50 in that order each time the pushbutton is pressed. Moreover, the pushbutton is structured to return to the value 10 when pressed. Given that in the example, a single pushbutton may be displayed per register, this reduces the total area taken up by the register value display area 103, thus saving on space.

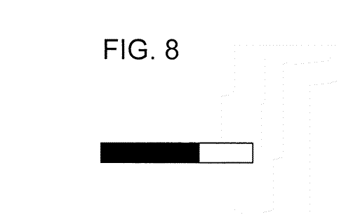

Alternatively, instead of the slide bar displayed for the register (OL8023) in the fourth row in FIG. 6, the display may be a bar graph as illustrated in FIG. 8. When a bar graph is displayed, specifying a desired position on the bar graph thus changes the display to a bar graph of the desired length, and the register value is also rewritten to a value corresponding to the length of the bar graph. In this case, the bar graph functions identically to the previously described slide bar, providing an intuitive means of numerical input.

Furthermore, the bar graph may be formed to change color in accordance with the register value. For instance, the bar graph may change to red when the register value is small, and change from yellow to green continuously in accordance with an increase in the register value. Alternatively, a single or two or more thresholds may be established such that the bar graph changes to a different color when the register value exceeds a threshold. In any case, the bar graph may be displayed in a series or discrete set of colors in accordance with the register value. Another alternative is to provide shades of color for the bar graph itself where, for instance, the left end of the bar graph is red, the center yellow, and the right end green. Otherwise, separate bar graphs of discrete colors may be displayed. If separate bar graphs of discrete colors are displayed, the bar graphs may be displayed so that the size and meaning of the register values may be understood intuitively.

Note that displaying the register values using colors in the above-described manner is not limited to using a bar graph. The previously described button, slide bar or the color of the cell in the register value display area 103 may change in accordance with the register value.

Incidentally, the register value display area 103 in FIG. 5 may be structured to display only the required registers and the values thereof, and not necessarily all the register values used in the ladder program. That is, the register value display unit 12 in FIG. 3 may read the current register values from the register value storage unit 11 and display the necessary registers on the monitor (2h).

The monitoring unit 10 can monitor the required register values using the above-described configuration when the registers that are necessary to be monitored, the method of rewrite input for the registers, and the display mode for the register value are all defined; however to achieve this, the aforementioned parameters are defined in advance.

The rewrite input selection command unit 16 in the monitoring unit 10 illustrated in FIG. 3 specifies for registers displayed in the register value display area 103 which of the first rewrite input receiving unit 13 in the second rewrite input receiving unit 14 will receive a rewrite input. The user may specify through the input device (2e) which of the receiving units will be used; however, for instance, a specific operation within the register value display area 103 in a cell displaying the register value, e.g., the right click of a mouse, or a long press on a touch screen panel, may cause a GUI element such as a pull-down menu or a dialog box to be displayed to accept the instruction from the user. Additionally, at this point, when the second rewrite input receiving unit 14 is selected, the display mode command unit 17 may also specify the mode of display for the register value in question. The display mode command unit 17 specifies what mode of display is used to display the register value, for example, whether to display a pushbutton, a slide bar, or the like in the above-described example. Moreover, the display mode command unit 17 sets the register value and a color associated with the pushbutton, or determines the shading and establishes a threshold when the color of the pushbutton is to change. Thus, an optimum mode for display may be selected in accordance with the properties of the register. Obviously, the mode for displaying the register value may be automatically specified by the display mode command unit 17.

The register selection unit 18 also selects the register that should be displayed in the register value display area 103. The instruction may be received via an appropriate dialog box displayed in accordance with a specific operation, e.g., selection of a menu item, and the like. Thus, a situation may be avoided where the user is presented with numerous registers that do not need monitoring, making it difficult for the user to monitor important register values.

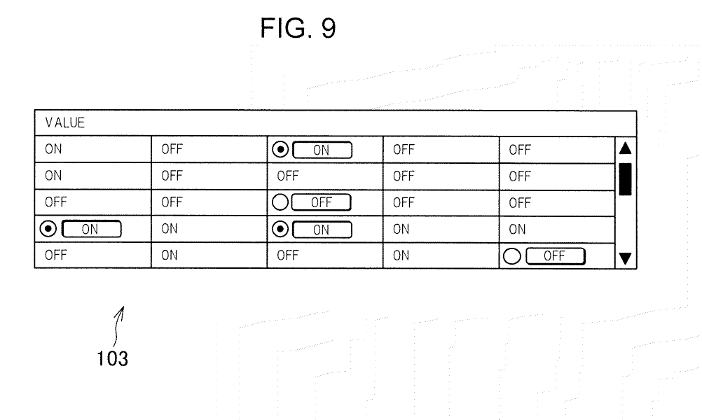

However, the register selection unit 18 may be structured to display a list of all registers to allow the user to specify for each register which of the first rewrite input receiving unit 13 or the second rewrite input receiving unit 14 is to accept the rewrite input therefor. FIG. 9 illustrates an example of the register value display area 103 when all the registers are displayed in a list. The second rewrite input receiving unit 14 is selected for a number of registers for which the register values are represented graphically with indicator lamps and pushbuttons. The first rewrite input receiving unit 13 is selected for the other registers for which numerical values (separately “ON” or “OFF”) are displayed.

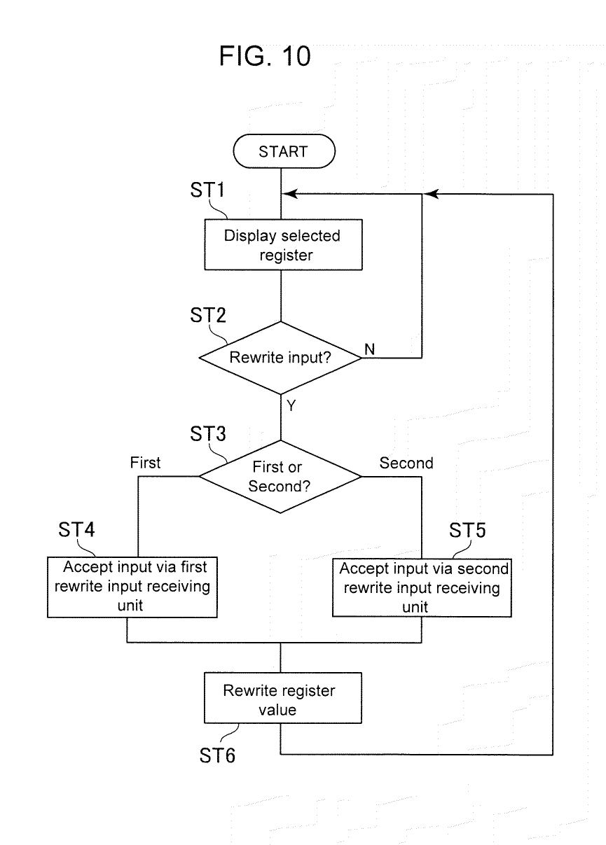

FIG. 10 is a flow diagram illustrating an operation for monitoring the register values using a monitoring unit 10. When monitoring starts, in step ST1 the register value display unit 12 first displays the register value selected by the register selection unit 18 in the register value display area 103 on the monitor (2h).

Next, in step ST2, the monitoring unit 10 waits for a rewrite input from the user via the input device (2e). If no rewrite input is received, control returns to step ST1, and to display the newest information, the register value display unit 12 displays the register value selected in real time in the register value display area 103 on the monitor (2h) again. If there is a rewrite input, control proceeds to step ST3.

In step ST3, the rewrite input selection unit 15 determines whether the rewrite input selection command unit 16 specified the first rewrite input receiving unit 13 or the second rewrite input receiving unit 14 for the register selected by the user. When the first rewrite input receiving unit 13 is specified, the first rewrite input receiving unit 13 is selected and control proceeds to step ST4. When the second rewrite input receiving unit 14 is specified, the second rewrite input receiving unit 14 is selected and control proceeds to step ST5.

In step ST4, the rewrite input is received by the first rewrite input receiving unit 13; in step ST5, the rewrite input is received by the second rewrite input receiving unit 14. In either case control proceeds to step ST6.

In step ST6 the register value stored in the register value storage unit 11 is rewritten in accordance with the rewrite input received. Thereafter, control returns to step ST1, and monitoring continues.

In the explanations thus far the ladder program creation device 2 monitors the register values. Thus, when creating a ladder program, or when verifying the operations thereof during maintenance the register values used in the ladder program may be easily verified and rewritten, improving the efficiency of creating or maintaining the ladder program. However, verifying and rewriting the register values used in the ladder program do not need to be performed in the ladder program creation device 2; there are cases where the ability to easily monitor the register values is desired.

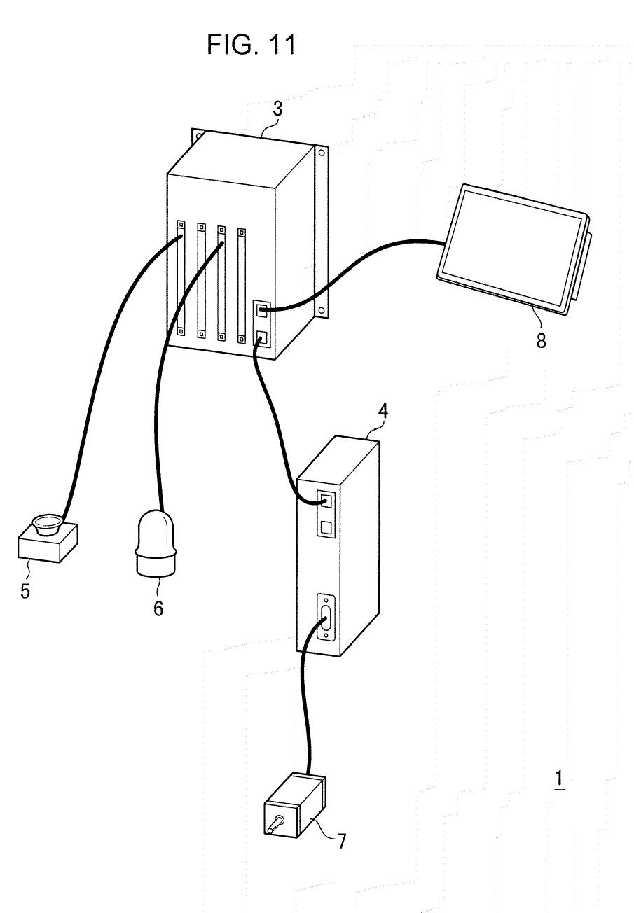

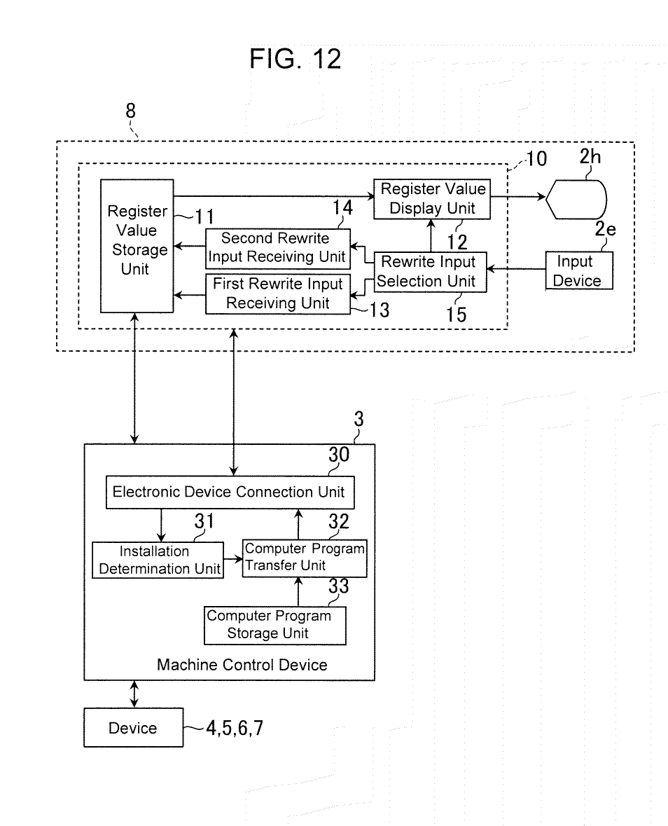

FIG. 11 provides an example of facilitating the verification and rewriting of the register values used in a ladder program. Namely, FIG. 11 illustrates an example configuration of a machine control system 1 wherein a monitoring device 8 is connected to the machine control device 3. FIG. 12 is a functional block diagram of a machine control system 1 for this case. In both drawings, the elements identical to those in previous examples are given identical reference numerals, and duplicate explanations are omitted.

A suitable electronic device, for example a portable device such as a tablet device, a personal digital assistant (PDA), or a smart phone, or the like may be used as the monitoring device. In FIG. 11, a touch screen panel is used as the monitoring device 8. The system configuration of the electronic device is basically identical to the configuration illustrated in FIG. 2; in many cases the electronic device is generally structured to function as a computer. Additionally, the electronic devices and the machine control device 3 may be connected via wire or wireless connection, or may be directly connected or connected via a network.

As is clear from FIG. 12, the monitoring unit 10 in the monitoring device 8 includes the register value storage unit 11, the register value display unit 12, the first rewrite input receiving unit 13 and the second rewrite input receiving unit 14, as well as the rewrite input selection unit 15. The other configuration elements illustrated in FIG. 3 are not necessarily required. Even with such a configuration, if the ladder program creation device 2 illustrated in FIG. 1 and FIG. 3 is used to select the register that should be displayed, and the method for providing the rewrite input therefor, and if a mode for display is specified, there should be no problem displaying and rewriting register values in the same manner as illustrated in FIGS. 6 to 10. Thus, compact devices having limited information processing power can be used as the monitoring device 8, even, for instance, the industrial touch screen panel provided here to exemplify the monitoring device 8.

Additionally, as illustrated in FIG. 12, an electronic device connection unit 30, an installation determination unit 31, a computer program transfer unit 32, and a computer program storage unit 33 may be selectively included in the machine control device 3.

Here, the computer program storage unit 33 stores a program that will cause the electronic device to function as the monitoring device 8. The electronic device connection unit 30 provides an interface for connecting the machine control device 3 and the electronic device, and in this case, can be connected via a wired or a wireless connection.

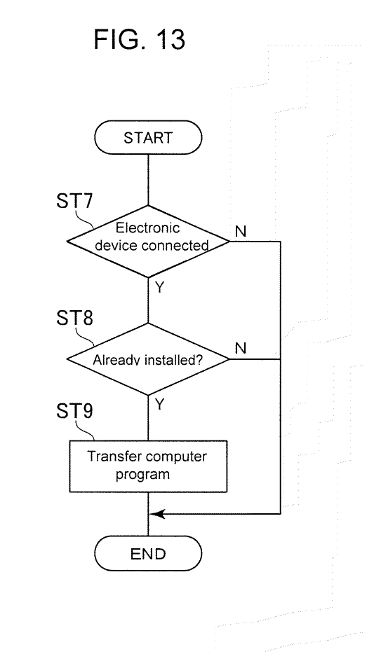

At this point, when the monitoring device 8 is connected to the electronic device connection unit 30, the machine control device 3 carries out the operations illustrated by the flow diagram in FIG. 13. First, in step ST7, the machine control device 3 determines whether or not any kind of electronic device is connected thereto. If no device is connected processing is terminated; if a device is connected, control proceeds to step ST8.

In step ST8, the machine control device 3 determines via the installation determination unit 31 whether or not a computer program for causing the electronic device to function as the monitoring device 8 is installed. If the computer program is already installed, processing is terminated; if the program is not installed, control proceeds to step ST9.

In step ST9 the computer program transfer unit 32 transfers the computer program stored in the computer program storage unit 33 to the electronic device via the electronic device connection unit 30. Consequently, even if modules that function as the monitoring device are not provided in advance, or the computer program that function as the monitoring device 8 is not installed, as long as the electronic device is connected to the machine control device 3, the electronic device may operate with the same functions as the monitoring device 8.

Additionally, the machine control device 3 may limit transferring the computer program only in cases the computer program is not installed on the electronic device, to thereby limit generating unnecessary communications. Monitoring of the register values is possible immediately without taking additional time after a single installation is complete.

Of course, the computer program the causes the electronic device to function as the monitoring device 8 does not necessarily need to be transferred from the machine control device 3; the computer program may be installed transferred from and installed via any kind of information communication network such as a separate internet, or an information storage medium such as a CD-ROM and the like. Furthermore, the computer program that causes the electronic device to function as the monitoring device 8 may be stored in the ladder program creation device 2 illustrated in FIGS. 1 to 3 and the computer program transferred from the ladder program creation device 2 and installed on the electronic device.

The configurations of the embodiments described above are merely for providing specific examples, and the invention disclosed in this specification is not intended to be limited thereby. A person skilled in the art may appropriately modify the embodiments disclosed herein in various ways, e.g., the form, number, or arrangement of the components or the parts thereof. Additionally, the person skilled in the art may substitute various other controls that provide identical functionality for the controls illustrated in the flowcharts herein. Finally, the technical scope of the invention described in this specification includes the above-described kinds of modifications thereto.

Ladder programs may be created on a computer using ladder program creation software. This kind of software may display the register values used in the ladder program and allows those values to be set as desired. A register value can be set by selecting the desired register on the computer screen and entering the desired value via a keyboard.

A ladder program creation device according to an embodiment of the invention includes a register value storage unit for storing a register value used in a ladder program; a register value display unit for displaying a register value stored in the register value storage unit in a register value display area; a first rewrite input receiving unit for accepting a rewrite input for a register displayed in the registered value display area by accepting entry of the value that should be written; a second rewrite input receiving unit for accepting the selection of at least one portion of the register value display area; and a rewrite input selection unit for selecting at least one of the first rewrite input receiving unit and the second rewrite input receiving unit.

Moreover, in a ladder program creation device according to an embodiment of the invention, the rewrite input selection unit may select at least one of the first rewrite input receiving unit and the second rewrite input receiving unit for each of at least one or more registers.

A ladder program creation device according to an embodiment of the invention further includes a rewrite input selection command unit that for each register specifies which of at least the first rewrite input receiving unit and the second rewrite input receiving unit should be selected; and a display mode command unit for specifying a mode of display by the register value display unit for a register when the second rewrite input receiving unit is selected.

A ladder program creation device according to an embodiment of the invention may further include a register selection unit for selecting the register for which a value is displayed in the register value display area.

In a ladder program creation device according to an embodiment of the invention, the register value display unit may change the state of the display in the register value display area in accordance with the results of the selection made by the rewrite input selection unit.

In a ladder program creation device according to an embodiment of the invention, the second the rewrite inputs receiving unit may switch between and select the register value from two or more predetermined values each time a rewrite input is received.

In a ladder program creation device according to an embodiment of the invention, the register value display unit may display a button in the register value display area, and the second rewrite input value receiving unit may switch the register value each time the button is selected.

In a ladder program creation device according to an embodiment of the invention, the register value display unit may display two or more buttons in the register value display area, and the second rewrite input value receiving unit may switch the register value to a value correspond to the button when the button is selected.

In a ladder program creation device according to an embodiment of the invention, the second rewrite input receiving unit may set the register value in accordance with a location selected in the register value display area when a rewrite input is received.

In a ladder program creation device according to an embodiment of the invention, the register value display unit may display a slide bar or a bar graph in the register value display area.

In a ladder program creation device according to an embodiment of the invention, the register value display unit may display the register value display area in a series of or a discrete set of defined colors in accordance with the register value.

A computer program according to an embodiment of the invention may cause a computer to function as the above-described ladder program creation device.

A monitoring device according to an embodiment of the invention includes the register value storage unit, the register value display unit, the first rewrite-input receiving unit, the second rewrite input receiving unit, and the rewrite input selection unit. The rewrite input selection unit may select at least one of the first rewrite input receiving unit and the second rewrite input receiving unit specified by the rewrite input selection command unit in the above-described ladder program creation device.

A computer program according to an embodiment of the invention may cause an electronic device to function as the above-described monitoring device.

A machine control device according to an embodiment of the invention includes a computer program storage unit that stores the above-described computer program; an electronic device connection unit for connecting to an external electronic device; and an installation determination unit for determining whether or not the computer program is installed on the electronic device; and a computer program transfer unit for transferring the computer program to the electronic device.

Obviously, numerous modifications and variations of the present invention are possible in light of the above teachings. It is therefore to be understood that within the scope of the appended claims, the invention may be practiced otherwise than as specifically described herein.

What is claimed is:

1. A ladder program device, comprising:
circuitry configured to
store a register value to be used in a ladder program,
display the register value in a register value display area, and
receive a selection for one of a first rewrite input and a second rewrite input for the register value displayed in the registered value display area, the circuitry configured to receive the selection by accepting the first rewrite input if a value to modify the register value is entered and accepting the second rewrite input if at least one portion of the register value display area is selected to modify the register value.

2. The ladder program device according to claim 1, wherein the circuitry is configured to receive the selection, for a second register value, of one of the first rewrite input and the second rewrite input.

3. The ladder program device according to claim 1, wherein the circuitry is configured to
specify which one of the first rewrite input and the second rewrite input is to be selected for the register value, and
specify a mode of display for the register value when the second rewrite input is selected.

4. The ladder program device according to claim 3, wherein the circuitry is configured to receive a selection of a register for which the register value is displayed in the register value display area.

5. The ladder program device according to claim 3, wherein the circuitry is configured to change the mode of the display in the register value display area in accordance with a result of the selection for one of the first rewrite input and the second rewrite input.

6. The ladder program device according to claim 5, wherein the circuitry is configured to switch and select the register value from a plurality of predetermined values each time the second rewrite input is accepted.

7. The ladder program device according to claim 6, wherein the circuitry is configured to
display a button in the register value display area, and
switch the register value each time the second rewrite input is accepted and the button is selected.

8. The ladder program device according to claim 6, wherein the circuitry is configured to
display a plurality of buttons in the register value display area, and
switch the register value to a value correspond to a selected button of the plurality of buttons each time the second rewrite input is accepted.

9. The ladder program device according to claim 5, wherein the circuitry is configured to
set the register value in accordance with a position selected in the register value display area when the second rewrite input is accepted.

10. The ladder program device according to claim 9, wherein the circuitry is configured to
display one of a slide bar and a bar graph in the register value display area.

11. The ladder program device according to claim 9, wherein the circuitry is configured to
display the register value display area in a series of or a discrete set of defined colors in accordance with the register value.

12. A method for monitoring a register value, comprising:
storing a register value to be used in a ladder program;
displaying the register value in a register value display area;
specifying which one of a first rewrite input and a second rewrite input for the register value displayed in the registered value display area is to be selected for the register value;
receiving a selection for one of the first rewrite input and the second rewrite input the register value by accepting the first rewrite input if a value to modify the register value is entered and accepting the second rewrite input if at least one portion of the register value display area is selected to modify the register value; and
specifying a mode of display for the register when the second rewrite input is selected.

13. The method for monitoring a register value according to claim 12, wherein the receiving comprises receiving the selection, for a second register, of one of the first rewrite input and the second rewrite input.

14. The method for monitoring a register value according to claim 12, further comprising:
selecting a register for which the register value is displayed in the register value display area.

15. The method for monitoring a register value according to claim 12, wherein the displaying comprises changing the mode of the display in the register value display area in accordance with a result of the selection for one of the first rewrite input and the second rewrite input.

16. The method for monitoring a register value according to claim 15, wherein the receiving comprises switching and selecting the register value from a plurality of predetermined values each time the second rewrite input is accepted.

17. The method for monitoring a register value according to claim 16, wherein the displaying comprises displaying a button in the register value display area, and the receiving comprises switching the register value each time the second rewrite input is accepted and the button is selected.

18. The method for monitoring a register value according to claim 16, wherein the displaying comprises displaying a plurality of buttons in the register value display area, and the receiving comprises switching the register value to a value correspond to a selected button of the plurality of buttons each time the second rewrite input is accepted.

19. The method for monitoring a register value according to claim 15, wherein the receiving comprises setting the register value in accordance with a position selected in the register value display area when the second rewrite input is accepted.

20. A machine control device, comprising:
a non-transitory computer readable medium having stored thereon a program that when executed by an external electronic device causes the external electronic device to execute a method of monitoring a register value, comprising storing the register value to be used in a ladder program, displaying the register value in a register value display area, specifying which one of a first rewrite input and a second rewrite input for the register value displayed in the registered value display area is to be selected for the register value, and receiving a selection for one of the first rewrite input and the second rewrite input for the register value by accepting the first rewrite input if a value to modify the register value is entered and accepting the second rewrite input if at least one portion of the register value display area is selected to modify the register value; and
circuitry configured to connect to the external electronic device, determine whether the program is installed on the external electronic device, and transfer the program to the electronic device if the program is not installed on the external electronic device.
